(19) United States
(12) Patent Application Publication
(10) Pub. No.: US 2023/0232902 A1
(43) Pub. Date: Jul. 27, 2023

(54) VAPORIZATION ASSEMBLY, VAPORIZER, AND ELECTRONIC VAPORIZATION DEVICE

(71) Applicant: Jiangmen Smoore New Material Co., Ltd., Jiangmen (CN)

(72) Inventors: Jianqing WU, Jiangmen (CN); Yan LIN, Jiangmen (CN); Yu ZHOU, Jiangmen (CN)

(21) Appl. No.: 18/095,219

(22) Filed: Jan. 10, 2023

(30) Foreign Application Priority Data
Jan. 24, 2022 (CN) 202220194583.6

(51) Int. Cl. A24F 40/46; A24F 40/10; A24F 40/48

(52) U.S. Cl. CPC A24F 40/46; A24F 40/10; A24F 40/48

(57) ABSTRACT

A vaporization assembly is disclosed. The vaporization assembly includes a base unit having a base and a sleeve that is joined to an end of the base. The sleeve has a cavity and at least one window in communication with the cavity. The vaporization assembly further includes a heating net disposed in the cavity and connected to the base, and a liquid guiding unit disposed in the cavity and covering an outside of the heating net. The liquid guiding unit is configured to guide vaporization liquid that flows into the liquid guiding unit through the window to the heating net.

### CROSS-REFERENCE TO RELATED APPLICATION

This application claims the benefit of priority to Chinese Patent Application No. 202220194583.6, filed on Jan. 24, 2022, the entire disclosure of which is incorporated by reference herein.

### TECHNICAL HELD

This disclosure relates to the field of vaporization technologies and, in particular, to a vaporization assembly, a vaporizer, and an electronic vaporization device.

### BACKGROUND

An aerosol is a colloidal dispersion system formed by solid or liquid small particles dispersing and suspending in a gas medium. Since the aerosol may be absorbed by a human body through the respiratory system, a new alternative absorption method is provided for a user. For example, vaporization devices that generate an aerosol from vaporization liquid such as a medical drug may be used in different fields such as medical treatment, to deliver an inhalable aerosol to the user and replace conventional product forms and absorption methods.

There is an uneven heat generation problem in vaporization assemblies used by some existing vaporization devices, leading to excessively high or low local heat, thereby causing dry burning or e-liquid explosion, and affecting the use experience of the electronic vaporization devices.

### SUMMARY

Based on this, it is necessary to provide a vaporization assembly, a vaporizer, and an electronic vaporization device for uneven heat generation of a vaporization assembly, and the vaporization assembly, the vaporizer, and the electronic vaporization device may achieve a technical effect of preventing uneven heat generation from affecting a vaporization effect.

According to an aspect of this application, a vaporization assembly is provided, including:

a base unit, including a base and a sleeve that is joined to an end of the base, where the sleeve has an accommodating cavity and at least one window that is in communication with the accommodating cavity;

a heating net, connected to the base and accommodated in the accommodating cavity; and

a liquid guiding unit, accommodated in the accommodating cavity and covering the outside of the heating net, where the liquid guiding unit is configured to guide vaporization liquid that flows into the liquid guiding unit through the window to the heating net, where

a single grid area of a region of the heating net corresponding to the window is smaller than a single grid area of the remaining regions of the heating net; or

a single grid area of a part of the heating net that is close to the base is smaller than a single grid area of a part of the heating net that is away from the base.

In an embodiment, the heating net includes multiple heating wires and multiple connecting wires, where the multiple heating wires are arranged at intervals in an axial direction of the sleeve, each of the multiple heating wires extends longitudinally in a circumferential direction of the sleeve, and each of the multiple connecting wires connects two adjacent heating wires to form multiple grids; and

a circumferential grid width of the region of the heating net corresponding to the window is smaller than a circumferential grid width of the remaining regions of the heating net.

In an embodiment, at least one window is a cutting slot extending in the axial direction of the sleeve, and the liquid guiding unit includes a main liquid guiding part that is arranged in the accommodating cavity and a cutting part that stretches into the cutting slot; and

a positive connection portion and a negative connection portion are arranged respectively on two ends in the circumferential direction of the sleeve by the heating net, where the positive connection portion and the negative connection portion are arranged at intervals in the circumferential direction of the sleeve to form a heating notch that communicates the main liquid guiding part, and the heating notch and the cutting part are aligned, staggered, or opposite to each other in the circumferential direction of the sleeve.

In an embodiment, the heating notch and the cutting part are opposite to each other in the circumferential direction of the sleeve; and

a circumferential grid width of a region of the heating net located on two sides of the heating notch is larger than a circumferential grid width of the remaining regions of the heating net.

in an embodiment, the heating notch and the cutting part are aligned in the circumferential direction of the sleeve; and

a circumferential grid width of a region of the heating net located on two sides of the heating notch is smaller than a circumferential grid width of the remaining regions of the heating net.

In an embodiment, the heating notch and the cutting part are staggered in the circumferential direction of the sleeve at an angle from 30° to 90°; and

a circumferential grid width of a region of the heating net that is close to the cutting part is smaller than a circumferential grid width of the remaining regions.

In an embodiment, the heating net includes multiple heating wires and multiple connecting wires, where the multiple heating wires are arranged at intervals in an axial direction of the sleeve, each of the multiple heating wires extends longitudinally in a circumferential direction of the sleeve, and each of the multiple connecting wires connects two adjacent heating wires to form multiple grids; and

an axial grid length of the heating net gradually increases from an end close to the base to an end away from the base.

In an embodiment, the heating net includes multiple heating wires, where the multiple heating wires are arranged at intervals in an axial direction of the sleeve, each of the multiple heating wires extends longitudinally in the circumferential direction of the sleeve, and a wire diameter of each of the multiple heating wires of the heating net gradually decreases from an end close to the base to an end away from the base.

According to another aspect of this application, a vaporizer is provided, including a liquid storage cavity and the foregoing vaporization assembly

According to another aspect of this application, an electronic vaporization device is provided, including a power supply component and the foregoing vaporizer, where the power supply component and the vaporizer are electrically connected.

According to the foregoing vaporization assembly, the heating efficiency of different regions of the heating net is adjusted by adjusting the single grid area of the heating net according to a position of the window or a distance relative to the base, and the vaporization liquid in a region that liquid guiding is relatively sufficient in the liquid guiding unit may be fully vaporized. Therefore, a generated aerosol has a good taste. In addition, the heating net is prevented from being overheated and burnt in a case that the liquid guiding is insufficient and the service life of the heating net is prolonged.

### BRIEF DESCRIPTION OF THE DRAWINGS

FIG. 1 is a schematic diagram of an electronic vaporization device according to an embodiment of the present disclosure;

FIG. 2 is a schematic diagram of an internal structure of a vaporizer of the electronic vaporization device shown in FIG. 1;

FIG. 3 is a schematic structural diagram of a vaporization assembly according to an embodiment of the present disclosure;

FIG. 4 is a schematic diagram of an internal structure of the vaporization assembly shown in FIG. 1;

FIG. 5 is a schematic diagram of an internal structure of the vaporization assembly shown in FIG. 1 viewed from another angle;

FIG. 6 is a schematic exploded diagram of the vaporization assembly shown in FIG. 1;

FIG. 7 is an expanded schematic view of a heating net according to an embodiment of the present disclosure;

FIG. 8 is a schematic diagram of an internal structure of a vaporization assembly according to another embodiment of the present disclosure;

FIG. 9 is a schematic diagram of an internal structure of the vaporization assembly shown in FIG. 8 viewed from another angle;

FIG. 10 is a schematic exploded diagram of the vaporization assembly shown in FIG. 8;

FIG. 11 is a schematic diagram of assembly of a heating net and a liquid guiding unit according to an embodiment of the present disclosure;

FIG. 12 is an expanded schematic view of the heating net shown in FIG. 11;

FIG. 13 is a schematic diagram of winding of the heating net shown in FIG. 11;

FIG. 14 is a schematic diagram of assembly of a heating net and a liquid guiding unit according to another embodiment of the present disclosure;

FIG. 15 is a schematic diagram of assembly of a heating net and a liquid guiding unit according to still another embodiment of the present disclosure;

FIG. 16 is an expanded schematic view of the heating net shown in FIG. 13;

FIG. 17 is a schematic diagram of winding of the heating net shown in FIG. 13;

FIG. 18 is an expanded schematic view of a heating net according to an embodiment of the present disclosure;

FIG. 19 is an expanded schematic view of a heating net according to another embodiment of the present disclosure. Descriptions of reference numerals:

100. Electronic vaporization device; 20. Power supply component; 40. Vaporizer; 41. Vaporization assembly; 411. Heating net; 4111. Heating wire; 4113. Connecting wire; 4115. Grid; 4117. Positive connection portion; 4119. Negative connection portion; 412. Heating notch; 413. Liquid guiding unit; 4132 Main liquid guiding part; 4134. Cutting part; 415, Base unit; 4152. Base; 4154. Sleeve; 4154a. Accommodating cavity; 4154b. Cutting slot; 4154c, Liquid inlet hole; 417. Outer liquid guiding unit; 419. liquid inlet tube; 4192. Liquid inlet; 43. Vaporization tube; 432. Liquid storage cavity; 434. Vaporization channel; 45. Mounting base.

### DETAILED DESCRIPTION

To make the foregoing objectives, features, and advantages of the present disclosure more comprehensible, detailed description is made to specific implementations of the present disclosure below with reference to the accompanying drawings. In the following description, many specific details are described for fully understanding the present disclosure, However, the present disclosure may be implemented in many other manners different from those described herein. A person skilled in the art may make similar improvements without departing from the connotation of the present disclosure. Therefore, the present disclosure is not limited to the specific embodiments disclosed below.

In the description of the present disclosure, it should be understood that, orientation or position relationships indicated by terms such as “center”, “longitudinal”, “transverse”_{;} “length”, width, “thickness”, “up”, “down”, “front”, “back”, “left”, “right”, “vertical”, “horizontal”, “top”, “bottom”, “inner”, “outer”, “clockwise”, “counterclockwise”, “axial”, and “circumferential” are orientation or position relationships shown based on the accompanying drawings, and are merely used for describing the present disclosure and simplifying the description, rather than indicating or implying that the indicated device or element should have a particular orientation or be constructed and operated in a particular orientation, and therefore, should not be construed as a limitation on the present disclosure.

In addition, the terms “first” and “second” are used merely for the purpose of description, and shall not be construed as indicating or implying relative importance or implying a quantity of indicated technical features. Therefore, features defining “first” and “second” can explicitly or implicitly include at least one of the features. In the description of the present disclosure, unless otherwise explicitly specified, “multiple” means at least two, such as two or three.

In the present disclosure, unless otherwise explicitly specified and defined, terms such as “mounted”, “connected”, “connection”, and “fixed” should be understood in broad sense, for example, the connection may be a fixed connection, a detachable connection, or an integral connection; or the connection may be a mechanical connection or an electrical connection; or the connection may be a direct connection, an indirect connection through an intermediary, or internal communication between two elements or a mutual action relationship between two elements, unless otherwise specified explicitly. A person of ordinary skill in the art can understand specific meanings of the foregoing terms in the present disclosure according to a specific situation.

In the present disclosure, unless otherwise explicitly specified or defined, a first feature “on” or “under” a second feature may be that the first feature is in direct contact with the second feature, or the first feature is in indirect contact with the second feature through an intermediary. Moreover, the first feature “over”, “above” and “up” the second feature may be that the first feature is directly above or obliquely above the second feature, or simply indicates that a horizontal height of the first feature is higher than that of the second feature. The first feature “under”, “below” and “down” the second feature may be that the first feature is directly below or obliquely below the second feature, or simply indicates that a horizontal height of the first feature is lower than that of the second feature.

It should be noted that, when a component is referred to as “being fixed to” or “being disposed on” another component, the component may be directly on the another component, or there may be an intermediate component. When a component is considered to be “connected to” another component, the component may be directly connected to the another component, or an intermediate component may also be present. The terms “vertical”, “horizontal”, “up”, “down”, “left”, “right” and similar expressions used in this specification are only for the purpose of illustration but not indicate a unique implementation.

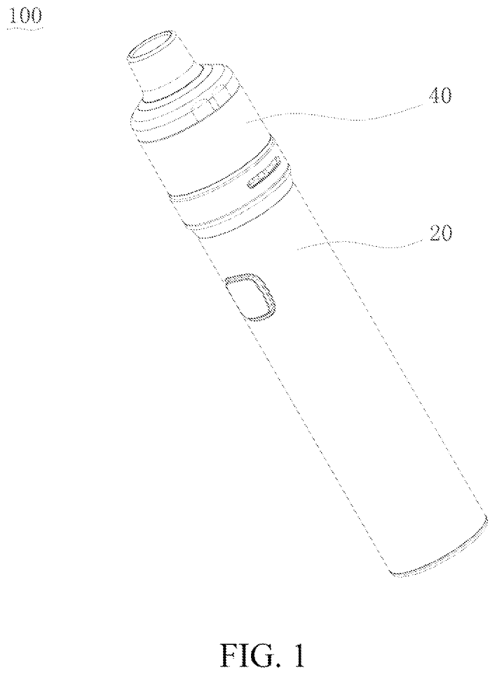

Referring to FIG. 1, an embodiment of the present disclosure provides an electronic vaporization device 100, where the electronic vaporization device 100 includes a power supply component 20 and a vaporizer 40, the power supply component 20 is electrically connected to the vaporizer 40, the vaporizer 10 is configured to store liquid-state vaporization liquid and may vaporize the liquid-state vaporization liquid under an action of electric energy of the power supply component 20 to generate an aerosol for a user to inhale.

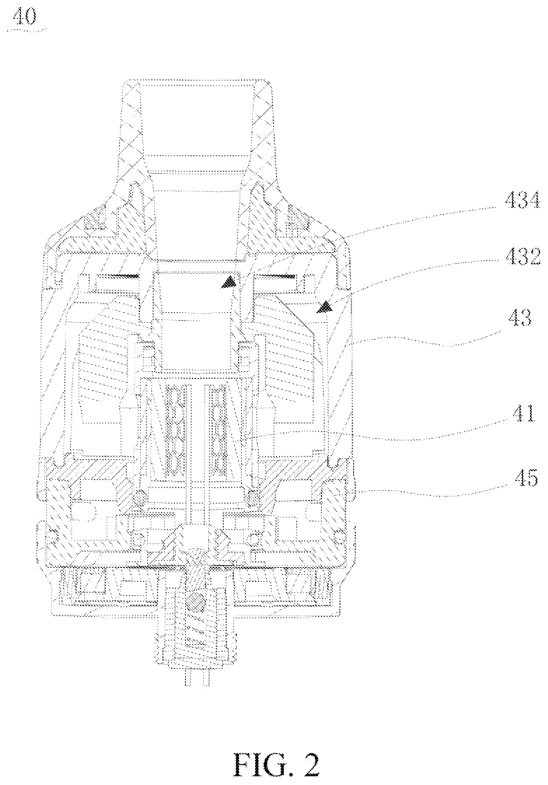

As shown in FIG. 2, the vaporizer 40 includes a vaporization assembly 41, a vaporization tube 13, and a mounting base 45. The vaporization tube 43 has a hollow housing-like structure, and an accommodating cavity, a liquid storage cavity 132, and a vaporization channel 434 are provided in the vaporization tube 43, where the liquid storage cavity 432 is provided around the vaporization channel 434 to store the liquid-state vaporization liquid, the accommodating cavity is provided on one end of the liquid storage cavity 432 for installing the vaporization assembly 41 and the mounting base 45, the vaporizer 40 is connected to a power supply component through the mounting base 45, and the vaporization assembly 41 is configured to vaporize the vaporization liquid. In this way, the vaporization liquid in the liquid storage cavity 432 enters the vaporization assembly 41 and is vaporized by the vaporization assembly 41, an aerosol generated through the vaporization flows out from the vaporizer 40 through the vaporization channel 434 to be inhaled by the user.

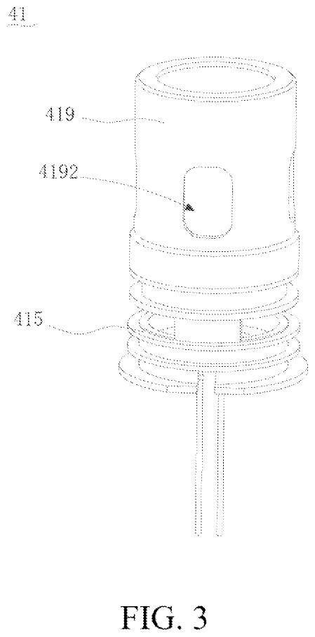

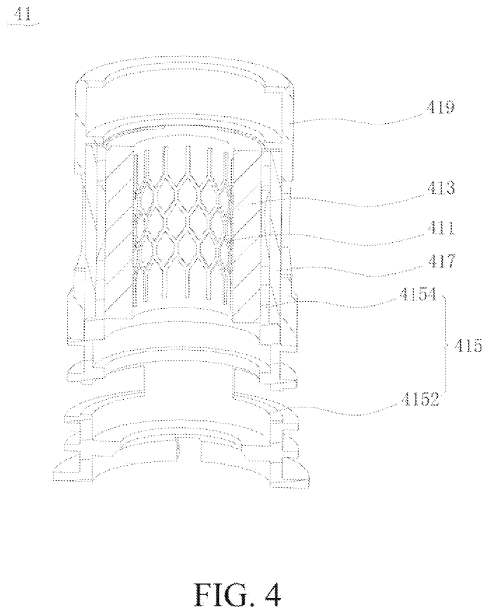

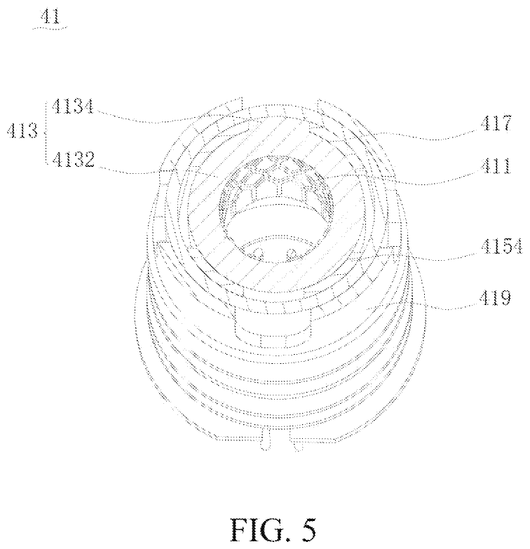

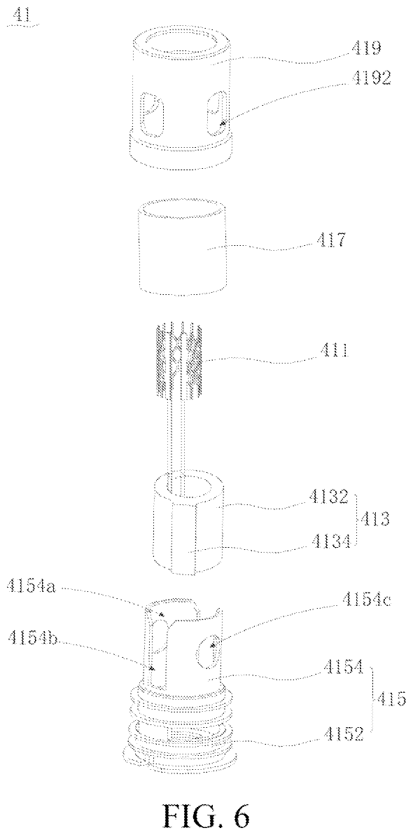

As shown in FIG. 3 to FIG. 6, the vaporization assembly 41 includes a base unit 415, a heating net 411 that is accommodated in the base unit 415, a liquid guiding unit 413 that is accommodated in the base unit 415 and covers the outside of the heating net 411, and an outer liquid guiding unit 417 and a liquid inlet tube 419 that are sequentially joined to the outside of the base unit 415. The liquid-state vaporization liquid in the vaporizer 40 may sequentially flow through the liquid inlet tube 419, the outer liquid guiding unit 417, and the base unit 415 to enter the liquid guiding unit 413 and finally reach a surface of the heating net 411, and the heating net 411 may heat and vaporize the vaporization liquid to generate an aerosol.

The heating net 411 in the vaporization assembly 41 is wound around an axis that extends in a first direction to form a shape of a cylinder. A structure of the heating net 411 is described below by taking a flat heating net 411 in an unfolded state as an example.

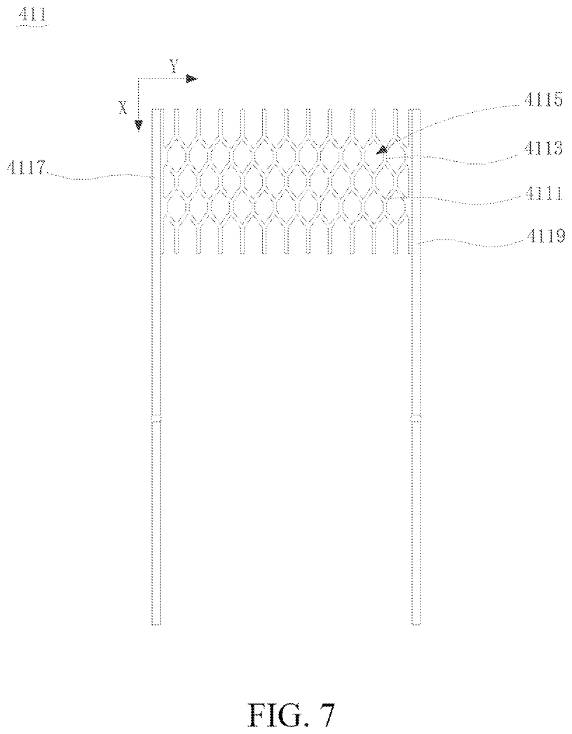

As shown in FIG. 7, the heating net 411 has a long-strip net structure, including multiple heating wires 4111, multiple connecting wires 4113, a positive connection portion 4117, and a negative connection portion 4119. The positive connection portion 4117 and the negative connection portion 4119 are electrically connected to a positive electrode and a negative electrode of the power supply component 20 respectively to supply power to the heating wires 4111. Certainly, it may be understood that the positive electrode and the negative electrode of the positive connection portion 4117 and the negative connection portion 4119 may be exchanged, and the “positive” and “negative” herein are merely relative concepts and do not limit the connection portions. The connecting wire 4113 is configured to connect two adjacent heating wires 4111 and improve the strength of the heating net 411; and the heating wire 4111 may generate heat under an action of electric energy to vaporize the vaporization liquid.

Specifically, the multiple heating wires 4111 are arranged at intervals in a first direction (such as a direction X in FIG. 7), and each of the multiple heating wires 4111 tortuously extends in a second direction (such as a direction Y in FIG. 7) to form wave peaks and wave troughs that are arranged alternately. The wave peaks and wave troughs of every two adjacent heating wires 4111 are opposite to each other in the first direction, where the wave peak of each of the multiple heating wires 4111 is connected to a wave trough of an adjacent heating wire 4111 that is close to the wave peak through a connecting wire 4113, and the wave trough of each of the multiple heating wires 4111 is connected to a wave peak of another adjacent heating wire 4111 that is close to the wave trough through another connecting wire 4113. The positive connection portion 4117 and the negative connection portion 4119 are respectively arranged on two opposite ends of the heating net 411 in the second direction, and are electrically connected to the power supply component 20 to supply power to the heating wires 4111.

In this way, every two adjacent heating wires 4111 are connected through one connecting wire 4113 to form a group of heating units, where every group of heating units includes multiple grids 4115, all the heating units are arranged in sequence in a width direction of the heating net 411, and all the grids 4115 in each group are arranged in sequence in the second direction of the heating net 411. In the embodiment of this application, the heating wire 4111 extends in an “M” shape, and the wave peak and wave trough of two adjacent heating wires 4111 are separated by a certain distance. Therefore, each grid 4115 has a hexagonal structure, a width direction of the grid 4115 extends in the second direction of the heating net 411, and a length direction of the grid 4115 extends in the first direction of the heating net 411. A circumferential grid width hereinafter refers to a width of a single grid 4115 in the second direction that can form an effective heating wire segment with an included angle less than 180°, and an axial grid length refers to a length of a single grid 4115 in the first direction that can form an effective heating wire segment with an included angle less than 180°.

Further, one end of some connecting wires 4113 is connected to the wave peak or wave trough of two heating wires 4111 that is arranged at the outermost side of the heating net 411 in the second direction, and the other end of the connecting wires 4113 extends in a direction away from the heating wire 4111 in the second direction and is configured to apply pressure to a liquid guiding unit 413 to prevent the liquid guiding unit 413 from curling.

It may be understood that a shape of the heating wire 4111 and a shape of the grid 4115 are not limited thereto, and may be set as required to meet different requirements. In some embodiments, the wave peaks and wave troughs of the heating wires 4111 may further be in a shape of an arc, a part of an oval, or other shapes, and a minimum distance between two adjacent heating wires 4111 may be zero or a certain distance. Therefore, the shape of the gird 4115 may be a circle, an oval, another polygon, or an irregular pattern.

To wrap the heating wires 4111 within the liquid guiding unit 413, the heating net 411 and the liquid guiding unit 413 are wound in the first direction to be in a shape of a cylinder, where the heating wires 4111 of the heating net 411 are wrapped inside the liquid guiding unit 413, the multiple groups of heating units are arranged in sequence in the first direction, and each grid 4115 in each group of the heating units is arranged in sequence in a circumferential direction. The positive connection portion 4117 and the negative connection portion 4119 extend from an end portion of the cylindrical liquid guiding unit 413 to facilitate an electrical connection to the power supply component 20; and the positive connection portion 4117 and the negative connection portion 4119 are arranged at intervals in the circumferential direction to form a heating notch 412. that extends longitudinally in the first direction.

Still referring to FIG. 3 to FIG. 6, the liquid guiding unit 413 is formed by a liquid guiding cotton. To absorb and provide enough vaporization liquid for the heating net 411, the liquid guiding cotton may have a plurality of layers. The plurality of layers of liquid guiding cottons are stacked in a thickness direction, and wrap the outside of the cylindrical heating net 411 in the first direction to form the cylindrical liquid guiding unit 413. The liquid guiding unit 413 is a porous structure and wraps an outer layer of the heating net to transmit the vaporization liquid for the heating net.

The base unit 415 includes a base 4152 and a sleeve 4154. Both the base 4152 and the sleeve 4154 approximately have a cylindrical structure, where the sleeve 4154 is joined to an end in an axial direction of the base 4152, the sleeve 4154 has an accommodating cavity 4154a that is configured to accommodate the heating net 411 and the liquid guiding unit 413, at least one window that is in communication with the accommodating cavity 4154a is provided on a side wall of the sleeve 4154, and the vaporization liquid may enter the accommodating cavity 4154a through the window.

In some embodiments, multiple windows are provided on the sleeve 4154, at least one window is a cutting slot 4154b that extends from one end to the other end in the first direction, and the remaining windows are circular liquid inlet hales 4154c. Specifically, in the following embodiments, four liquid inlet holes 4154c and one cutting slot 4154b are provided on the sleeve 4154, and the cutting slot 4154b is provided between two adjacent liquid inlet holes 4154c. In another embodiment, two liquid inlet holes 4154c and two cutting slots 4154b are provided on the sleeve 4154, and the two cutting slots 4154b are provided on two opposite sides in a circumferential direction of the sleeve 4154. It may be understood that the number and shape of the cutting slots 4154b and the liquid inlet holes 4154c, and positions at which the cutting slots 4154b and the liquid inlet holes 4154c are provided are not limited, and may be set as required to meet different requirements.

In this way, the liquid guiding unit 413 is installed in the sleeve 4154 and forms a cylindrical main liquid guiding part 4132, a redundant part of the liquid guiding unit 413 extends out of the base unit 415 through the cutting slot 4154b and is cut, a part remains in the cutting slot 4154b forms a cutting part 4134 that protrudes from an outer peripheral surface of the main liquid guiding part 4132, and the cutting part 4134 extends from one end of the main liquid guiding part 4132 to the other end of the main liquid guiding part 4132 in the axial direction of the main liquid guiding part 4132. The heating net 411 is attached to an inner surface of the main liquid guiding part 4132 in the circumferential direction, and the heating notch 412 is in communication with the main liquid guiding part 4132, or the heating notch 412 and the cutting part 4134 are overlapped.

The outer liquid guiding unit 417 is formed by a liquid guiding cotton, and the outer liquid guiding unit 417 wraps the outside of the sleeve 4154 in the first direction for guiding the vaporization liquid into the sleeve 4154.

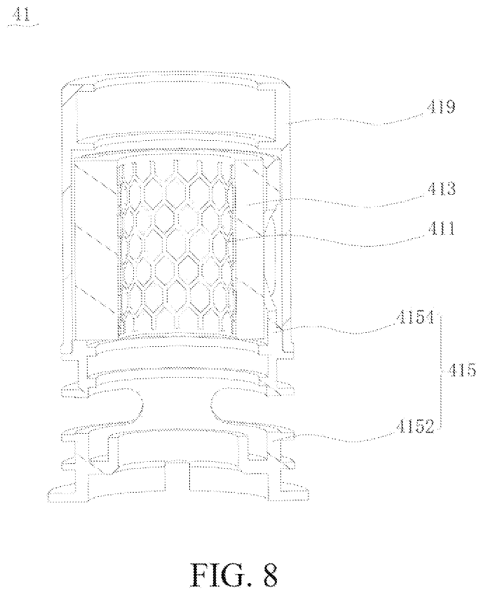

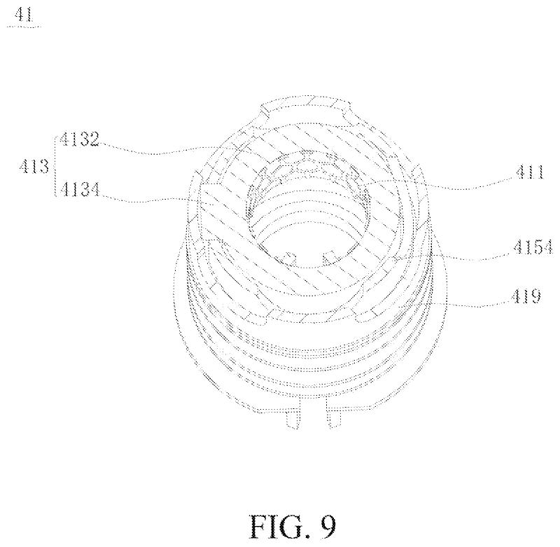

The liquid inlet tube 419 has a cylindrical structure, and the liquid inlet tube 419 is sleeved outside the outer liquid guiding unit 417, where multiple liquid inlets 4192 are provided on a side wall of the liquid inlet tube 419, the multiple liquid inlets 4192 are arranged at intervals in the circumferential direction, and the vaporization liquid outside the liquid inlet tube 419 may enter the outer liquid guiding unit 417 through the liquid inlets 4192. It may be understood that the number and the shape of the liquid inlets 4192 and positions at which the liquid inlets are provided are not limited, and may be set as required. As shown in FIG. 8 to FIG. 10, in some embodiments, the outer liquid guiding unit 417 may not be arranged in the vaporization assembly 41, the liquid inlet tube 419 is directly sleeved outside the base unit 415, and the vaporization liquid outside the liquid inlet tube 419 may enter the liquid guiding unit 413 through the liquid inlets 4192 and the liquid inlet holes 4154c.

Further, as an exemplary implementation, when the outer liquid guiding unit 417 is arranged in the vaporization assembly 41, each liquid inlet 4192 of the liquid inlet tube 419 and each liquid inlet hole 4154c of the sleeve 4154 are provided in a one-to-one correspondence, thereby enhancing a liquid guiding function. When the outer liquid guiding unit 417 does not exist in the vaporization assembly 41, each liquid inlet 4192 of the liquid inlet tube 419 and each liquid inlet hole 4154c of the sleeve 4154 are arranged in a staggered manner, so as to control a liquid guiding rate of the liquid guiding unit 413.

In the foregoing vaporization assembly 41, due to an existence of the window on the sleeve 4154, the liquid guiding rates of parts of the liquid guiding unit 413 in the circumferential direction are different. Specifically, a region of the liquid guiding unit 413 that is arranged corresponding to the window has a faster liquid guiding rate and sufficient liquid supplying is ensured, while a region of the liquid guiding unit 413 that is away from the window has a slower liquid guiding rate and insufficient liquid supplying easily occurs. Generally, a middle position of the heating net 411 with an evenly set grid area in the circumferential direction is a high temperature region with a relatively high temperature, and two opposite ends thereof in the circumferential direction are low temperature regions with a relatively low temperature. Therefore, if the low temperature region of the heating net 411 is in contact with a region with a higher liquid guiding rate in the liquid guiding unit 413, the vaporization liquid cannot be fully vaporized, and if the high temperature region of the heating net 411 is in contact with a region with a lower liquid guiding rate in the liquid guiding unit 413, the heating net 411 may be burnt.

To minimize a difference of vaporization effects due to different liquid guiding rates caused by the window provided on the sleeve 4154, in some embodiments of this application, a single grid area of a region of the heating net 411 corresponding to the window region is smaller than a single grid area of remaining regions of the heating net 411. In this way, a smaller single grid area of the heating net 411 indicates a higher heating efficiency of the heating net per unit area, so that the region of the heating net 411 corresponding to the window has a relatively high heating efficiency and forms a high temperature region, thereby fully vaporizing the vaporization liquid that enters the liquid guiding unit 413 through the window, and therefore a generated aerosol has a good taste. In addition, a region of the heating net 411 that is away from the window has a relatively low heating efficiency and forms a low temperature region, which can prevent the heating net 411 from being overheated and burnt when the liquid guiding is insufficient, and prolong the service life of the heating net 411.

It should be noted that grids 4115 of the region of the heating net 411 corresponding to the window may include not only a grid 4115 that faces the window in a radial direction, but further include a grid 4115 arranged at an edge of the window and a grid 4115 that is close to the window, and the vaporization liquid heated by the grids 4115 is mainly from a corresponding window thereof.

Specifically, in some embodiments, an area of the grid 4115 is adjusted by changing a circumferential grid width of the grid 4115, and specifically, a circumferential grid width of the region of the heating net 411 corresponding to the window is smaller than a circumferential grid width of the remaining regions of the heating net 411.

Further, since the cutting part 4134 is formed by stacking a plurality of layers of liquid guiding cottons in a radial direction of the main liquid guiding part 4132, the vaporization liquid may quickly enter the main liquid guiding part 4132 from a gap between two adjacent layers of liquid guiding cottons. As a result, the liquid guiding rate of a side of the liquid guiding unit 413 that is provided with the cutting part 4134 is faster and liquid supplying is the most sufficient, and the liquid guiding rate of the other side of the liquid guiding unit 413 that faces away from the cutting part 4134 in the circumferential direction is relatively slower and the liquid supplying is insufficient. In addition, different assembling manners lead to different relative positions of the cutting slot 4154b and the heating notch 412 of the heating net 411. However, a temperature near the heating notch 412 is lower, and a temperature of a side that is away from the heating notch 412 is higher, so that vaporization effects are different. Therefore, according to a position relationship between the cutting part 4134 and the heating notch 412, this application adaptively adjusts circumferential grid widths of different regions of the heating net 411, so that the liquid guiding rate of the liquid guiding unit 413 matches the heating efficiency of the heating net 411.

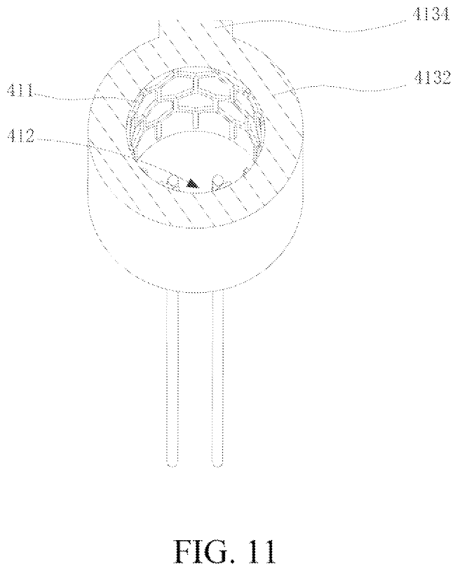

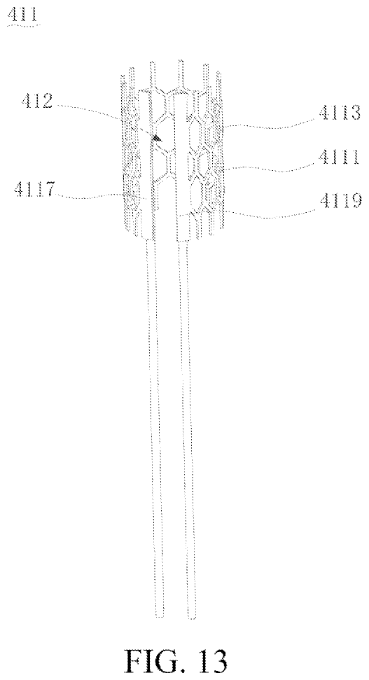

As shown in FIG. 11 to FIG. 13, in an embodiment of this application, the heating notch 412 and the cutting part 4134 are opposite to each other in the circumferential direction of the sleeve 4154. The circumferential grid width of a single grid 4415 of a region of the heating net 411 that is located on two sides of the heating notch 412 in the circumferential direction is larger and an overall arrangement is relatively sparse, and the circumferential grid width of the single grid 4415 of a region that is away from the heating notch and is close to the cutting part is smaller and an overall arrangement is relatively tight.

In this way, the single grid area of the region of the heating net 411 that is located on two sides of the heating notch 412 is larger than the single grid area of the remaining regions of the heating net 411. Therefore, the region of the heating net 411 that is located on two sides of the heating notch 412 forms a low temperature region with lower heating efficiency, and the region of the heating net 411 corresponding to the cutting part 4134 forms a high temperature region with higher heating efficiency. The high temperature region of the heating net 411 my fully vaporize the vaporization liquid that flows out from the cutting part 4134, while the low temperature region of the heating net 411 may not be burnt and damaged due to insufficient liquid guiding.

It should be noted that opposite arrangement of the heating notch 412 and the cutting part 4134 in the circumferential direction of the base not only includes a case that the heating notch 412 and the cutting part 4134 are provided on two opposite ends in a radial direction, and the heating notch 412 and the cutting part 4134 may be staggered in the circumferential direction of the base at an angle from 150° to 210°.

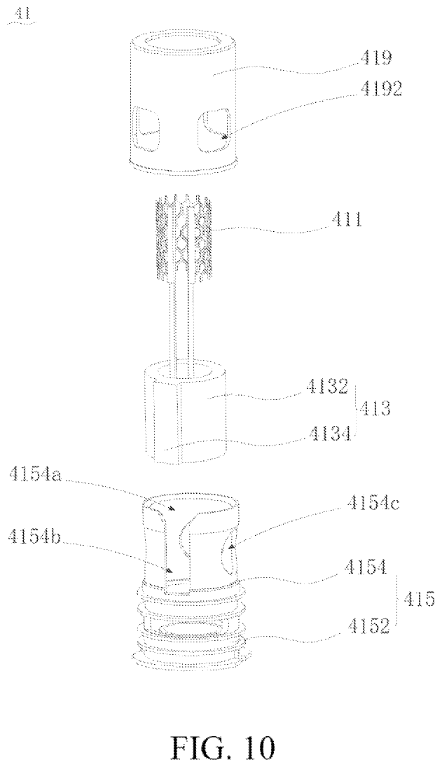

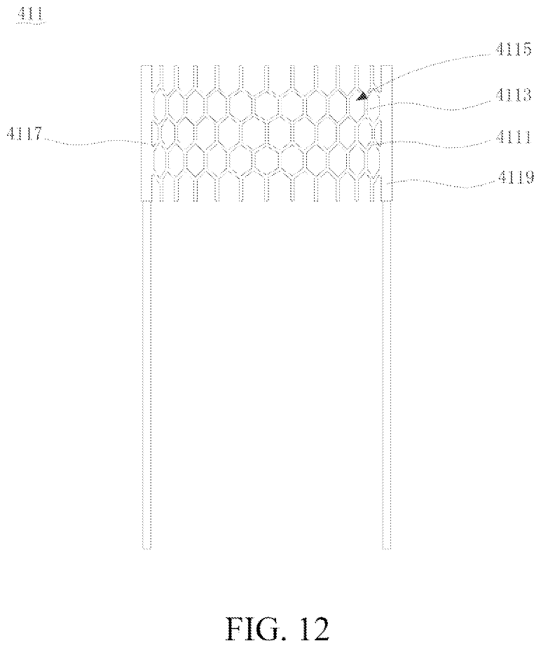

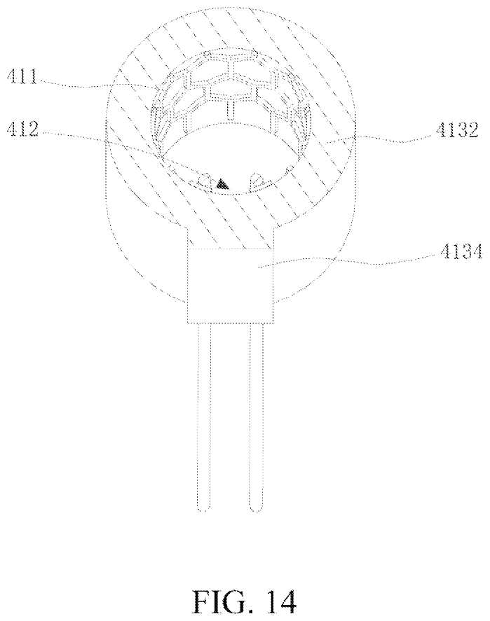

As shown in FIG. 10, FIG. 12, and FIG. 14, in still another embodiment of this application, the heating notch 412 and the cutting part 4134 are aligned in the circumferential direction of the sleeve 4154. The circumferential grid width of a single grid 4415 of the region of the heating net 411 that is located on two sides of the heating notch 412 is smaller and the overall arrangement is relatively tight, while the circumferential grid width of the single grid 4415 that is away from the heating notch 412 is larger and the overall arrangement is relatively sparse.

in this way, the single grid area of the region of the heating net 411 that is located on two sides of the heating notch 412 is smaller than the single grid area of the remaining regions of the heating net 411. Therefore, the region of the heating net 411 that is located on two sides of the heating notch 412 forms a high temperature region with higher heating efficiency, and the region of the heating net 411 that is away from the heating notch 412 forms a low temperature region with lower heating efficiency. The high temperature region of the heating net 411 may fully vaporize the vaporization liquid that flows out from the cutting part 4134, while the low temperature region of the heating net 411 may not be burnt and damaged due to insufficient liquid guiding,

It should be noted that opposite arrangement of the heating notch 412 and the cutting part 4134 in the circumferential direction of the base not only includes a case that the heating notch 412 and the cutting part 4134 are exactly overlapped in the circumferential direction, and the heating notch 412 and the cutting part 4134 may be staggered in the circumferential direction of the base at an angle that is less than 30°.

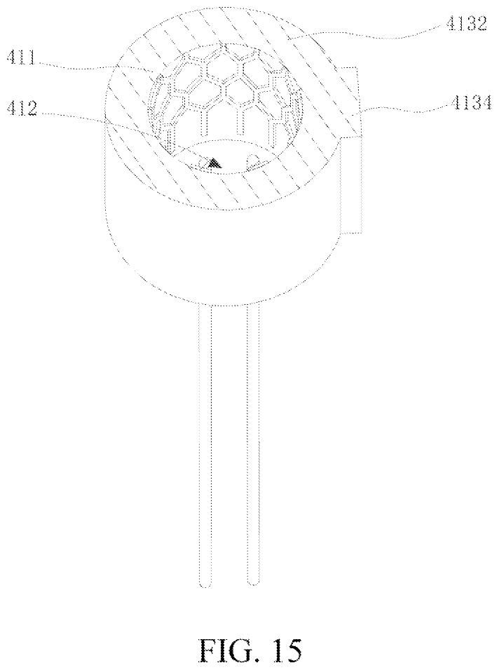

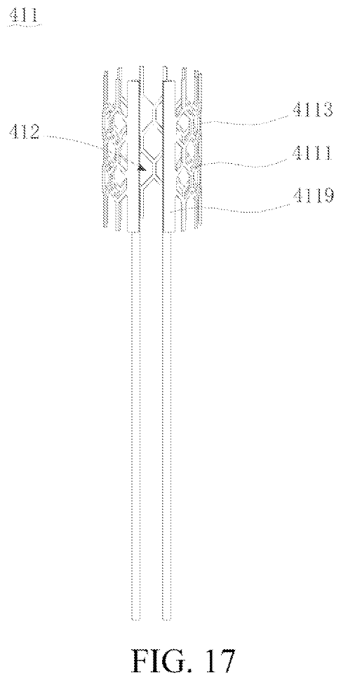

As shown in FIG. 15 to FIG. 17, in yet another embodiment of this application, the heating notch 412 and the cutting part 4134 are staggered in the circumferential direction of the base at an angle from 30° to 90. The circumferential grid width of the single grid 4415 on one side of the heating net 411 that is close to the cutting part 4134 from the heating notch 412 in the circumferential direction is smaller and the overall arrangement is relatively tight, and the circumferential grid width of the single grid 4415 on the other side that is away from the cutting part 4134 from the heating notch 412 in the circumferential direction is larger and the overall arrangement is relatively sparse.

In this way, the single grid area of the region of the heating net 411 that is close to the cutting part 4134 is smaller than the single grid area of the remaining regions. Therefore, the region of the heating net 411 that is close to one side of the cutting part 4134 forms a high temperature region with higher heating efficiency, and the region of the heating net 411 that is away from the cutting part 4134 forms a low temperature region with lower heating efficiency. The high temperature region of the heating net 411 may fully vaporize the vaporization liquid that flows out of the cutting part 4134, and the low temperature region of the heating net 411 may not be burnt and damaged due to insufficient liquid guiding.

in conclusion, according to the relative position of the cutting part 4134 and the heating notch 412, a liquid guiding rate of each position of the liquid guiding unit 413 may be deduced, so as to adjust the single grid area of each region of the heating net 411. For example, by reducing the circumferential grid width of a region of the heating net 411 corresponding to the main liquid. guiding part 4132 with a faster liquid guiding rate, and increasing the circumferential grid width of a region of the heating net 411 corresponding to the main liquid guiding part 4132 with a slower liquid guiding rate, the purpose of improving a taste and prolonging the service life may be achieved.

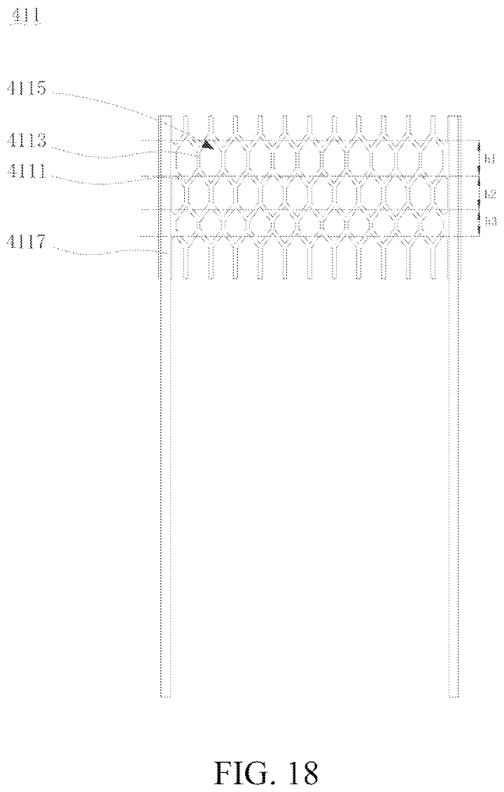

In some embodiments, cool air is mixed from one end of the vaporization assembly 41 that is close to the power supply component 20 to the other end that is away from the power supply component 20 in the first direction. A heating wire 4111 that is arranged upstream of an airflow flow direction (close to the power supply component 20) is easily cooled, while a heating wire 4111 arranged downstream (away from the power supply component 20) is prone to be overheated. As a result, the heating wire 4111 arranged downstream of the airflow flow direction is prone to be burnt, which affects the service life of the heating wire 4111. In addition, due to the effect of gravity, the vaporization liquid has a hydraulic difference in the first direction. Generally, hydraulic pressure on the end of the vaporization assembly 41 that is close to the power supply component 20 is greater than hydraulic pressure on the end that is away from the power supply component 20. Therefore, the liquid guiding rate of the end of the heating net 411 that is close to the power supply component 20 in the first direction is faster, so that the liquid guiding is more sufficient. To resolve the problem, as shown in FIG. 18, a single grid area of a part of the heating net 411 that is close to the base 4152 is smaller than a single grid area of a part of the heating net 411 that is away from the base 4152.

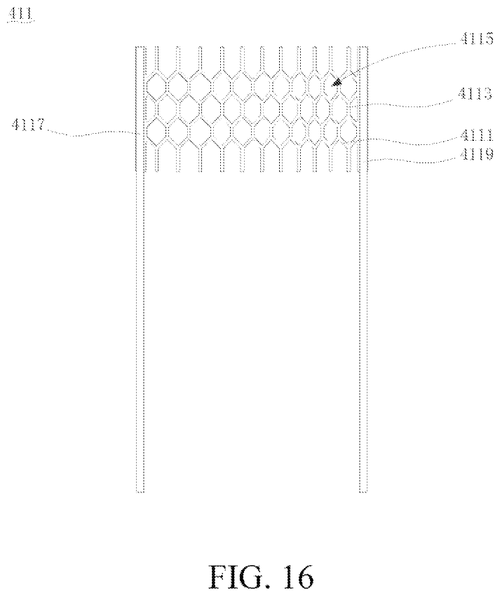

Specifically, in the first direction, an axial grid length of a single grid of the heating net 411 gradually increases from an end close to the base 4152 to an end away from the base 4152, that is, a distance between every two adjacent heating wires 4111 in the first direction gradually increases from one end that is close to the base 4152 to the other end that is away from the base 4152 (that is, h3<h2<h1 in FIG. 16). In this way, a temperature of the end of the heating net 411 that is away from the base 4152. is reduced, and dry burning due to insufficient liquid guiding is avoided. In addition, it is ensured that a part of the heating net 411 with a fast liquid guiding rate fully vaporizes the vaporization liquid, thereby improving a taste and the service life of the electronic vaporization device.

It should be noted that the distance between the two adjacent heating wires 4111 in the first direction is a distance between median lines (such as the dotted lines in FIG. 18) of the two heating wires 4111.

it may be understood that, as an exemplary embodiment, the axial grid length of a single grid of the heating net 411 may be changed only in a local region according to the liquid guiding rate of the liquid guiding unit 413, thereby accurately changing a temperature in the local region. Specifically, in some embodiments, an axial grid length of the region of the heating net 411 that is away from the heating notch in the circumferential direction is larger, and an axial grid length of the region of the heating net 411 that is dose to the heating notch in the circumferential direction is smaller.

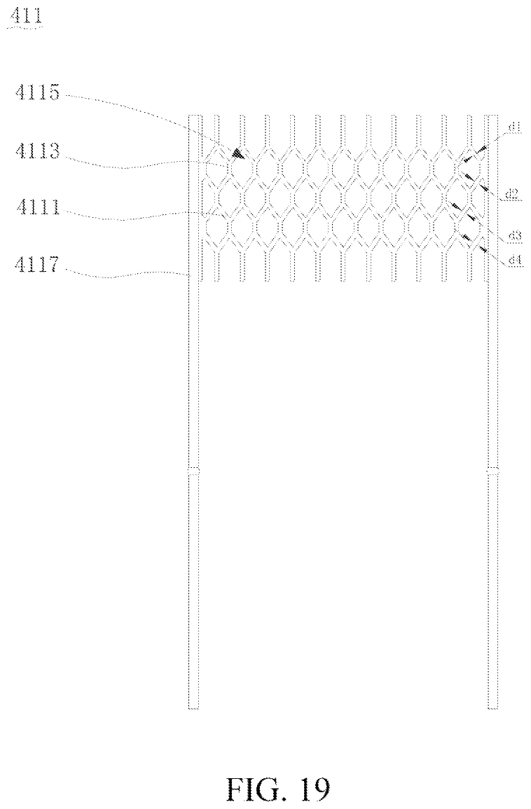

In some other embodiments, a wire diameter of the heating wire 4111 of the heating net 411 gradually decreases from the end that is close to the base 4152 to the end that is away from the base 4152, which may further adjust vaporization effects of different regions of the heating net 411. The wire diameter of the heating wire 4111 is in direct proportion to a temperature thereof A lower temperature of the heating wire 4111 indicates a smaller wire diameter that may be designed of the heating wire 4111. Specifically, as shown in FIG. 19, a diameter d of a heating wire 4111 gradually increases from the end away from the base 4152 to the end close to the base 4152, that is: d1≤d2≤d3≤d4, where d1<d4.

The foregoing vaporization assembly 41 and vaporizer 40 may fully vaporize and heat a region with sufficient liquid guiding in the liquid guiding unit 413 by adjusting the single grid area of the heating net 411 and the wire diameter of the heating wire 4111, which improves the taste, prevents the heating net 411 corresponding to the region with insufficient liquid guiding from being burnt and causing dry burning, and improves the service life of the heating net 411.

The technical features in the foregoing embodiments may be randomly combined. For concise description, not all possible combinations of the technical features in the embodiments are described. However, provided that combinations of the technical features do not conflict with each other, the combinations of the technical features are considered as falling within the scope described in this specification.

The foregoing embodiments only describe several implementations of the present disclosure specifically and in detail, but cannot be construed as a limitation to the patent scope of the present disclosure. It should be noted that, a person of ordinary skill in the art may still make various changes and improvements without departing from the idea of the present disclosure, and the changes and improvements shall all fall within the protection scope of the present disclosure. Therefore, the protection scope of the present disclosure is subject to the appended claims.

What is claimed is:

1. A vaporization assembly, comprising:
a base unit, comprising a base and a sleeve that is joined to an end of the base, wherein the sleeve has a cavity and at least one window in communication with the cavity;
a heating net disposed in the cavity and connected to the base; and
a liquid guiding unit disposed in the cavity and covering an outside of the heating net, the liquid guiding unit being configured to guide a vaporization liquid that flows into the liquid guiding unit through the window to the heating net, wherein:
a single grid area of a region of the heating net corresponding to the window is smaller than a single grid area of remaining regions of the heating net; or
a single grid area of a part of the heating net that is close to the base is smaller than a single grid area of a part of the heating net that is away from the base.

2. The vaporization assembly according to claim 1, wherein the heating net comprises multiple heating wires and multiple connecting wires, the multiple heating wires are arranged at intervals in an axial direction of the sleeve, each of the multiple heating wires extends longitudinally in a circumferential direction of the sleeve, and each of the multiple connecting wires connects two adjacent heating wires to form multiple grids; and
a circumferential grid width of the region of the heating net corresponding to the window is smaller than a circumferential grid width of the remaining regions of the heating net.

3. The vaporization assembly according to claim 1, wherein the at least one window is a cutting slot extending in the axial direction of the sleeve, and the liquid guiding unit comprises a main liquid guiding part that is located in the cavity and a cutting part that stretches into the cutting slot; and
a positive connection portion and a negative connection portion are arranged respectively on two ends in the circumferential direction of the sleeve by the heating net, the positive connection portion and the negative connection portion are arranged at intervals in the circumferential direction of the sleeve to form a heating notch that communicates the main liquid guiding part, and the heating notch and the cutting part are aligned, staggered, or opposite to each other in the circumferential direction of the sleeve.

4. The vaporization assembly according to claim 3, wherein the heating notch and the cutting part are disposed opposite to each other in the circumferential direction of the sleeve; and
a circumferential grid width of a region of the heating net located on two sides of the heating notch is larger than a circumferential grid width of the remaining regions of the heating net.

5. The vaporization assembly according to claim 3, wherein the heating notch and the cutting part are aligned in the circumferential direction of the sleeve; and
a circumferential grid width of a region of the heating net located on two sides of the heating notch is smaller than a circumferential grid width of the remaining regions of the heating net.

6. The vaporization assembly according to claim 3, wherein the heating notch and the cutting part are staggered in the circumferential direction of the sleeve at an angle from 30° to 90°; and
a circumferential grid width of a region of the heating net that is close to the cutting part is smaller than a circumferential grid width of the remaining regions.

7. The vaporization assembly according to claim 1, wherein the heating net comprises multiple heating wires and multiple connecting wires, the multiple heating wires are arranged at intervals in an axial direction of the sleeve, each of the multiple heating wires extends longitudinally in a circumferential direction of the sleeve, and each of the multiple connecting wires connects two adjacent heating wires to form multiple grids; and
an axial grid length of the heating net gradually increases from an end close to the base to an end away from the base.

8. The vaporization assembly according to claim 1, wherein the heating net comprises multiple heating wires, the multiple heating wires are arranged at intervals in an axial direction of the sleeve, each of the multiple heating wires extends longitudinally in the circumferential direction of the sleeve, and a wire diameter of each of the multiple heating wires of the heating net gradually decreases from an end close to the base to an end away from the base.

9. A vaporizer, comprising:
a liquid storage cavity; and
a vaporization assembly including:
a base unit, comprising a base and a sleeve that is joined to an end of the base, wherein the sleeve has a cavity and at least one window in communication with the cavity;
a heating net disposed in the cavity and connected to the base; and
a liquid guiding unit disposed in the cavity and covering an outside of the heating net, the liquid guiding unit being configured to guide a vaporization liquid that flows into the liquid guiding unit through the window to the heating net, wherein:
a single grid area of a region of the heating net corresponding to the window is smaller than a single grid area of remaining regions of the heating net; or
a single grid area of a part of the heating net that is close to the base is smaller than a single grid area of a part of the heating net that is away from the base.

10. The vaporizer according to claim 9, wherein the heating net comprises multiple heating wires and multiple connecting wires, the multiple heating wires are arranged at intervals in an axial direction of the sleeve, each of the multiple heating wires extends longitudinally in a circumferential direction of the sleeve, and each of the multiple connecting wires connects two adjacent heating wires to form multiple grids; and
a circumferential grid width of the region of the heating net corresponding to the window is smaller than a circumferential grid width of the remaining regions of the heating net.

11. The vaporizer according to claim 9, wherein the at least one window is a cutting slot extending in the axial direction of the sleeve, and the liquid guiding unit comprises a main liquid guiding part that is located in the cavity and a cutting part that stretches into the cutting slot; and
a positive connection portion and a negative connection portion are arranged respectively on two ends in the circumferential direction of the sleeve by the heating net, the positive connection portion and the negative connection portion are arranged at intervals in the circumferential direction of the sleeve to form a heating notch that communicates the main liquid guiding part, and the heating notch and the cutting part are aligned, staggered, or opposite to each other in the circumferential direction of the sleeve.

12. The vaporizer according to claim 11, wherein the heating notch and the cutting part are disposed opposite to each other in the circumferential direction of the sleeve; and
a circumferential grid width of a region of the heating net located on two sides of the heating notch is larger than a circumferential grid width of the remaining regions of the heating net.

13. The vaporizer according to claim 11, wherein the heating notch and the cutting part are aligned in the circumferential direction of the sleeve; and
a circumferential grid width of a region of the heating net located on two sides of the heating notch is smaller than a circumferential grid width of the remaining regions of the heating net.

14. The vaporizer according to claim 11, wherein the heating notch and the cutting part are staggered in the circumferential direction of the sleeve at an angle from 30° to 90°; and
a circumferential grid width of a region of the heating net that is close to the cutting part is smaller than a circumferential grid width of the remaining regions.

15. The vaporizer according to claim 9, wherein the heating net comprises multiple heating wires and multiple connecting wires, the multiple heating wires are arranged at intervals in an axial direction of the sleeve, each of the multiple heating wires extends longitudinally in a circumferential direction of the sleeve, and each of the multiple connecting wires connects two adjacent heating wires to form multiple grids; and
an axial grid length of the heating net gradually increases from an end close to the base to an end away from the base.

16. The vaporizer according to claim 9, wherein the heating met comprises multiple heating wires, the multiple heating wires are arranged at intervals in an axial direction of the sleeve, each of the multiple heating wires extends longitudinally in the circumferential direction of the sleeve, and a wire diameter of each of the multiple heating wires of the heating net gradually decreases from an end close to the base to an end away from the base.

17. An electronic vaporization device, comprising:
a power supply component, and a vaporizer electrically connected to the power supply component, the vaporizer comprising:
a liquid storage cavity; and
a vaporization assembly including:
a base unit, comprising a base and a sleeve that is joined to an end of the base, wherein the sleeve has a cavity and at least one window in communication with the cavity;
a heating net disposed in the cavity and connected to the base; and
a liquid guiding unit disposed in the cavity and covering an outside of the heating net, the liquid guiding unit being configured to guide a vaporization liquid that flows into the liquid guiding unit through the window to the heating net, wherein:
a single grid area of a region of the heating net corresponding to the window is smaller than a single grid area of remaining regions of the heating net; or
a single grid area of a part of the heating net that is close to the base is smaller than a single grid area of a part of the heating net that is away from the base.

18. The electronic vaporization device according to claim 17, wherein the heating net comprises multiple heating wires and multiple connecting wires, the multiple heating wires are arranged at intervals in an axial direction of the sleeve, each of the multiple heating wires extends longitudinally in a circumferential direction of the sleeve, and each of the multiple connecting wires connects two adjacent heating wires to form multiple grids; and
a circumferential grid width of the region of the heating net corresponding to the window is smaller than a circumferential grid width of the remaining regions of the heating net.

19. The electronic vaporization device according to claim 17, wherein the at least one window is a cutting slot extending in the axial direction of the sleeve, and the liquid guiding unit comprises a main liquid guiding part that is located in the cavity and a cutting part that stretches into the cutting slot; and
a positive connection portion and a negative connection portion are arranged respectively on two ends in the circumferential direction of the sleeve by the heating net, the positive connection portion and the negative connection portion are arranged at intervals in the circumferential direction of the sleeve to form a heating notch that communicates the main liquid guiding part, and the heating notch and the cutting part are aligned, staggered, or opposite to each other in the circumferential direction of the sleeve.

20. The electronic vaporization device according to claim 17, wherein the heating net comprises multiple heating wires and multiple connecting wires, the multiple heating wires are arranged at intervals in an axial direction of the sleeve.
